(19) United States
(12) Patent Application Publication
(10) Pub. No.: US 2018/0236806 A1
(43) Pub. Date: Aug. 23, 2018

(54) INTERACTIVE BOOK COVERING

(71) Applicant: Arthur J. HOFFMAN, Woodbridge, NJ (US)

(72) Inventor: Arthur J. HOFFMAN, Woodbridge, NJ (US)

(21) Appl. No.: 15/440,694

(22) Filed: Feb. 23, 2017

(51) Int. Cl. B42D 3/12; B42D 3/08; B42D 3/00; B42D 3/18

(52) U.S. Cl. CPC B42D 3/123; B42D 3/18; B42D 3/002; B42D 3/08

(57) ABSTRACT

An interactive book covering is provided. The interactive book covering includes a backer, one or more securing mechanisms for securing the backer to a cover of a book, one or more flaps coupled to the backer and configured to fold over a front cover of the backer, and one or more picture holders coupled to the backer, each picture holder being configured to secure one or more pictures.

### CLAIM OF PRIORITY

This application is a United States non-provisional application and claims no priority to any previous United States patent application.

### FIELD OF THE EMBODIMENTS

This invention relates to book coverings and, in particular, to an interactive book covering configured to enable a user to record and play one or more audio files.

### BACKGROUND OF THE EMBODIMENTS

Books are often given as gifts. However, the only typical method of personalizing the gift is to simply write on or within the book. There is no simple method available to leave an accompanying audio message with the gift of a book or easy way to leave an accompanying pictorial gift other than to insert the pictorial gift within the book. An easy and user-friendly method/apparatus is thus needed to enable users to accompany books or other similar objects with audio and/or visual messages/gifts/identifications.

Examples of related art are described below:

U.S. Pat. No. 9,349,308 generally describes systems and methods for dynamically applying a single design across a display field composed of visual surfaces of a number of non-adjoined product packages to create an impression of a single, unified aesthetic. Geometries and layouts of product packages are used to calculate a display field. A source image can be mapped to some or all of the display field to generate one or more field maps. Individual package images can be generated from the field maps, according to various factors, including the individual product package geometries and layouts. Some embodiments allow the generated package images to be previewed, the entire display field to be virtually previewed, and/or the package images to be output.

U.S. Pat. No. 9,077,823 generally describes a photo-based project and associated printed photobook having a flush photo collage, or montage, on the front cover. In one embodiment, a photobook is made by receiving a plurality of images corresponding to a photo-project; storing said plurality of images in a data repository; receiving a print order for a printed photobook corresponding to the photo-project; in response to the print order, printing a photo-strip having one or more of the images; producing a front cover by compressing a compressible cover material to form a channel in the compressible cover material, wherein the channel is of a size and a shape matching the photo-strip; wrapping the compressible cover material with the channel around a cover board to make the front cover; and setting the photo-strip permanently into the channel and flush with the front cover to create the photobook.

U.S. Pat. No. 8,448,595 generally describes a bookmark system that accommodates a plurality of bookmarks that are able to be selectively added and removed from a centralized head. Each bookmark is capable of sliding independently along a pin and is designed to fit between two pages of a book. The bookmark includes a member for secure integration to the book to ensure that it and its associated bookmarks remain in place during use of the book.

U.S. Patent Publication No. 2013/0113825 generally describes systems and methods for dynamically applying a single design across a display field composed of visual surfaces of a number of non-adjoined product packages to create an impression of a single, unified aesthetic. Geometries and layouts of product packages are used to calculate a display field. A source image can be mapped to some or all of the display field to generate one or more field maps. Individual package images can be generated from the field maps, according to various factors, including the individual product package geometries and layouts. Some embodiments allow the generated package images to be previewed, the entire display field to be virtually previewed, and/or the package images to be output.

U.S. Patent Publication No. 2012/0305569 generally describes packaging material, including an inner structural material and an outer surface material. The inner structural material is a hollow material, and the outer surface material is attached onto an outer surface of the inner structural material. And a method for producing the packaging material includes: a) producing a middle structural material comprising a cavity or channel, and sandwiching the middle structural material with an outer face material and an inner face material to yield a semi-finished hollow material; and b) attaching the outer surface material onto an outer surface of the hollow material.

Japanese Patent No. JP10166757A generally describes a cover for a book wherein the cover has a soft polyvinyl chloride synthetic resin sheet on a surface, wherein embossed parts, such as characters or a pattern, are embossed on the sheet, and wherein a hard polyvinyl chloride synthetic resin sheet or film is superposed on a rear side of the sheet. The parts are then aligned simultaneously upon thermal fusion bonding of the connecting surfaces of both of the sheets to provide the cover for a book, notebook, file, or a binder.

Great Britain Patent No. GB2250956A generally describes a cover for a binder e.g. a ring binder, or book, comprises a central spine and opposed cover members hingedly connected to the spine. The spine terminates short of the cover members and the corners of the cover members both adjacent to and remote from the spine are of rounded form. The rounded corners are less susceptible to damage when packaged.

International Patent Publication No. WO2016069300 generally describes a photo-based project and associated printed photobook having a flush photo collage, or montage, on the front cover. In one embodiment, a photobook is made by receiving a plurality of images corresponding to a photo-project; storing said plurality of images in a data repository; receiving a print order for a printed photobook corresponding to the photo-project; in response to the print order, printing a photo-strip having one or more of the images; producing a front cover by compressing a compressible cover material to form a channel in the compressible cover material, wherein the channel is of a size and a shape matching the photo-strip; wrapping the compressible cover material with the channel around a cover board material to make the front cover; and setting the photo-strip into the channel and flush with the front cover to create the photobook. An aesthetically pleasing photobook is thereby manufactured.

European Patent Publication No. EP2535186 generally describes a packaging material, a manufacturing method and a packaging tool thereof. Said packaging material comprises an inner structural material and an outer layer material, wherein said inner structural material is a hollow material, and said outer layer material is adhered to the outside surface of said inner structural material. The inner structural material comprises a middle layer material, and, provided on two sides thereof, a surface layer material and an inner layer material. Said packaging tool, made from said packaging material, comprises an inner structure formed by folding the inner structural material and an outer layer provided on the outside surface of said inner structure. In this invention, environmentally friendly and renewable hollow materials are used to produce inner structure by folding, and by incorporating an outer layer to produce a packaging tool which is suitable for containing goods.

None of the art described above addresses all of the issues that the present invention does.

### SUMMARY OF THE EMBODIMENTS

According to an aspect of the present invention, an interactive book covering is provided. The interactive book covering includes a backer, one or more securing mechanisms for securing the backer to a cover of a book, one or more flaps coupled to the backer and configured to fold over a front cover of the backer, and one or more picture holders coupled to the backer, each picture holder being configured to secure one or more pictures.

According to another aspect of the present invention, an interactive book covering is presented. The interactive book covering includes a backer, one or more securing mechanisms for securing the backer to a cover of a book, wherein the one or more securing mechanisms are selectively removable from the cover of the book, and one or more electric components coupled to the backer, wherein the one or more electric components include a memory configured to store one or more audio recordings, a processor configured to send the one or more audio recordings to a speaker, and the speaker configured to play the one or more audio recordings. The interactive book covering further includes one or more flaps coupled to the backer and configured to fold over a front cover of the backer, and one or more picture holders coupled to the backer, each picture holder being configured to secure one or more pictures.

It is an object of the present invention to provide for the interactive book covering, wherein the interactive book covering further includes one or more batteries configured to power one or more electric components coupled to the backer.

It is an object of the present invention to provide for the interactive book covering, wherein the one or more electric components include a memory configured to store one or more audio recordings, a processor configured to send the one or more audio recordings to a speaker, and the speaker configured to play the one or more audio recordings.

It is an object of the present invention to provide for the interactive book covering, wherein the one or more electric components include a microphone configured to record one or more audio files.

It is an object of the present invention to provide for the interactive book covering, wherein the one or more electric components include one or more light sources.

It is an object of the present invention to provide for the interactive book covering, wherein the one or more flaps, when folded over the front cover of the backer, cover the one or more picture holders.

It is an object of the present invention to provide for the interactive book covering, wherein the one or more securing mechanisms are selectively removable from the cover of the book.

It is an object of the present invention to provide for the interactive book covering, wherein the one or more securing mechanisms are foldable.

It is an object of the present invention to provide for the interactive book covering, wherein the one or more securing mechanisms are rigid and configured to enable the cover of the book to be inserted into an opening formed by the one or more securing mechanisms.

It is an object of the present invention to provide for the interactive book covering, wherein the one or more securing mechanisms include an adhesive.

### BRIEF DESCRIPTION OF THE DRAWINGS

FIG. 1 shows a front view of an interactive book covering having folded flaps, according to an embodiment of the present invention.

FIG. 2 shows a rear view of an interactive book covering having unfolded flaps, according to an embodiment of the present invention.

FIG. 3 shows a front view of an interactive book covering having unfolded flaps, according to an embodiment of the present invention.

FIG. 4 shows a front view of an interactive book covering having unfolded flaps, according to an embodiment of the present invention.

FIG. 5 shows a front view, and internal components, of an interactive book covering having unfolded flaps, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

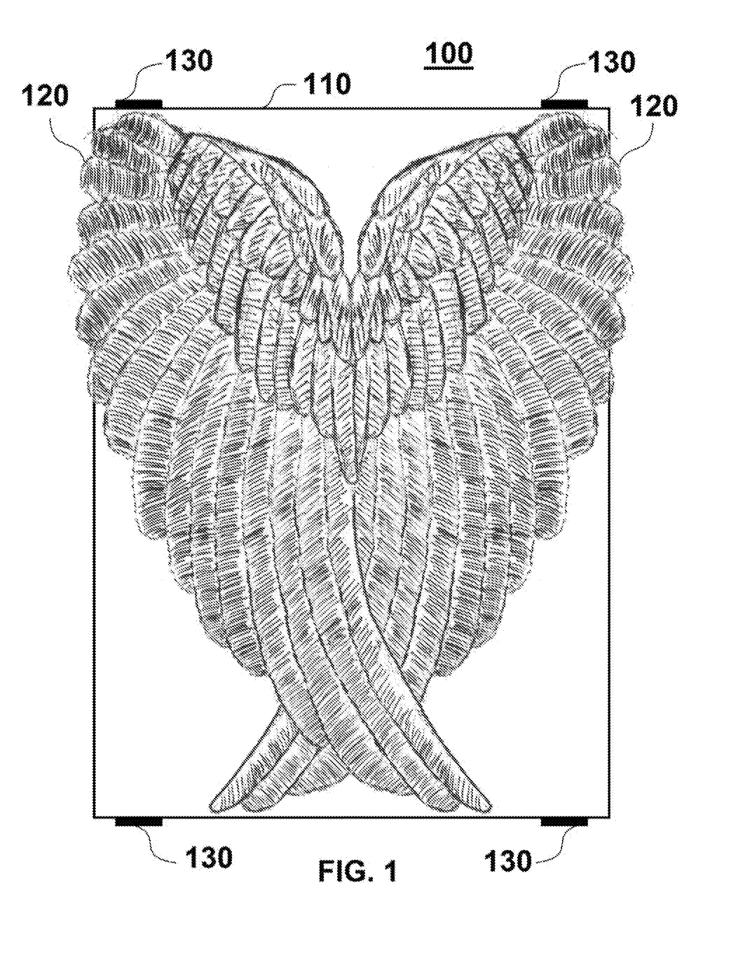

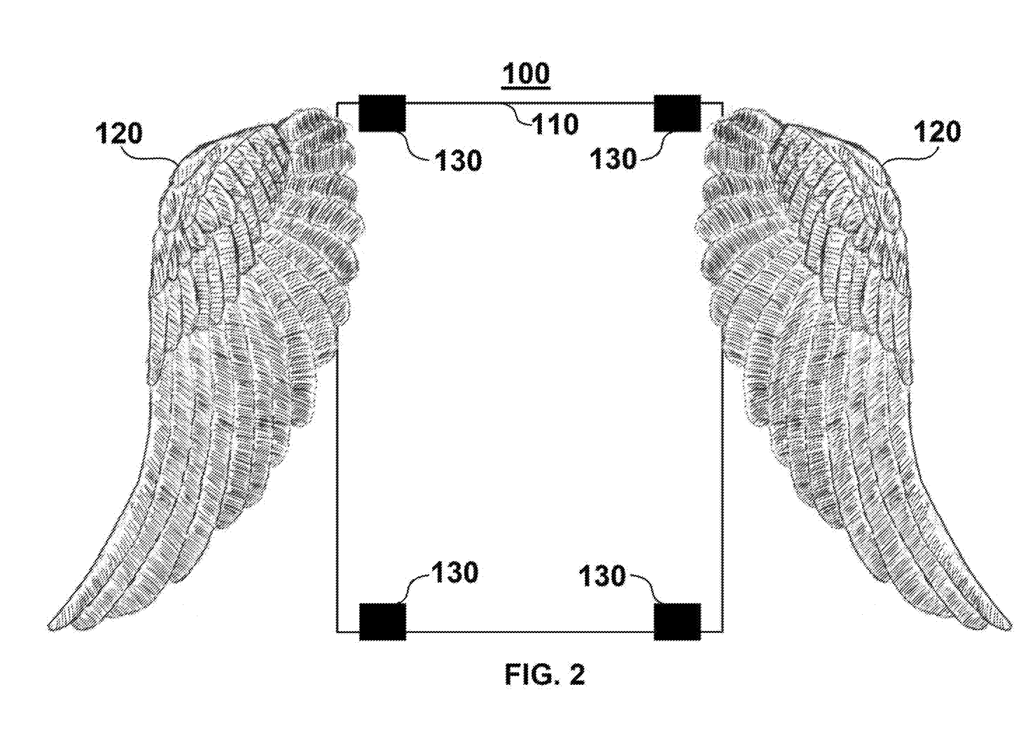

Referring now to FIGS. 1 and 2, a front view of an interactive book covering 100 having folded flaps 120 (FIG. 1) and a rear view of an interactive book covering 100 having unfolded flaps 120 (FIG. 2) are illustratively depicted, in accordance with embodiments of the present invention.

According to an embodiment, the interactive book covering 100 includes a backer 110, one or more flaps 120, and one or more securing mechanisms 130.

The interactive book covering includes one or more flaps 120 coupled to the backer 110 such that the one or more flaps 120 are able to fold and unfold around the area at which the flap 120 and backer 110 are coupled. According to the embodiment shown in FIGS. 1-5, the flaps 120 are in the shape of wings and are reverse images of one another. However, other shapes may also be used to make the flaps 120 and the flaps need not be mirror images of each other.

When in the folded position, the flaps 120 in FIGS. 1-5 overlap such that one flap 120 is on top of the other flap 120. In other embodiments, the flaps 120 may be of a shape configured to not overlap when in a folded position. Also shown in FIGS. 1-5, the interactive book covering 100 includes two flaps 120. According to various embodiments, the interactive book covering 100 includes one or more flaps, while maintaining the spirit of the present invention.

The interactive book covering 100 includes one or more securing mechanisms 130. These securing mechanisms 130 are configured such that the interactive book covering 100 can be secured to a surface, such as the cover of a book. According to an embodiment, the securing mechanism 130 includes an adhesive. According to an embodiment, the securing mechanism 130 includes a pliable material configures to enable a user to bend one or more securing mechanisms 130 around a surface to secure the interactive book covering 100 to the surface. According to an embodiment, the securing mechanism 130 includes a rigid surface configured to enable a surface, such as the cover of a book, to slide through a gap formed by the securing mechanism 130, securing the interactive book covering 100 to the surface. According to an embodiment, the securing mechanisms 130 are selectively removable from the book or other surface.

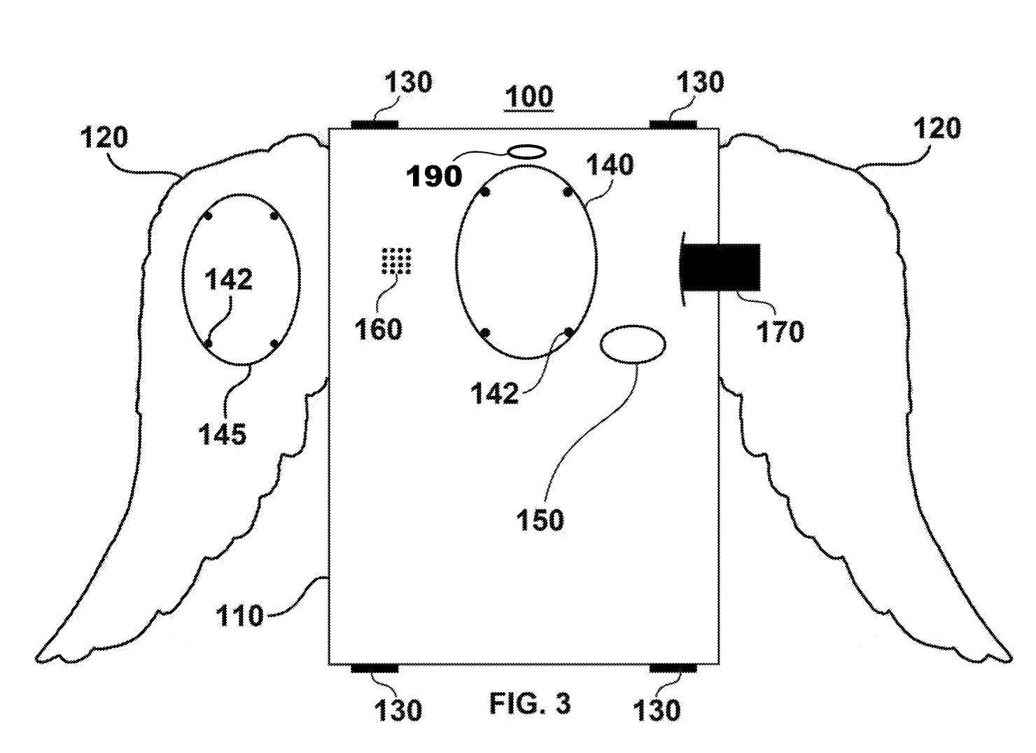

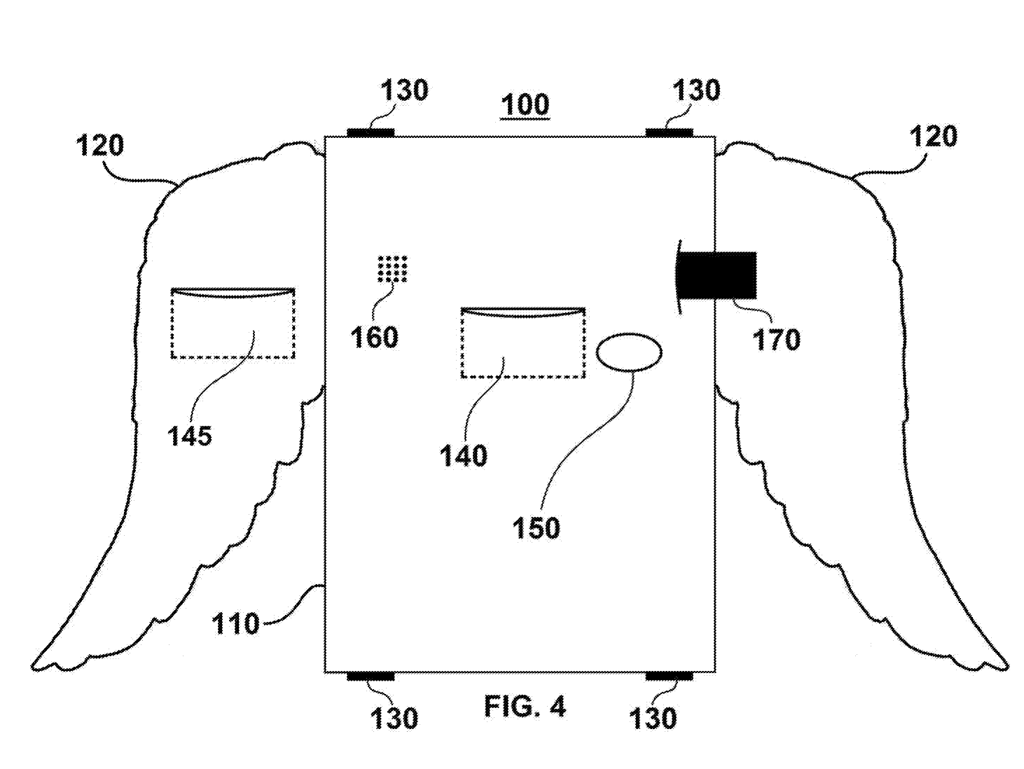

Referring now to FIGS. 3 and 4, front views of an interactive book covering 100 having unfolded flaps 120 are illustratively depicted, in accordance with an embodiment of the present invention.

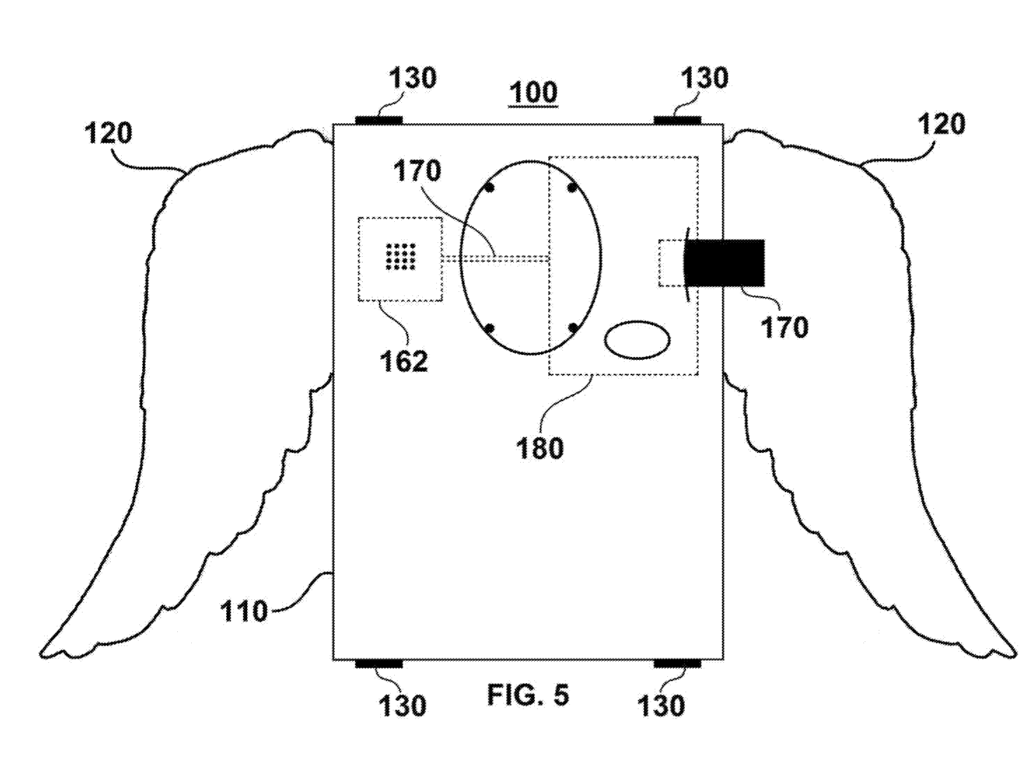

The one or more flaps 120 are capable of unfolding, revealing the front portion of the backer 110. According to an embodiment, the front portion of the backer 110 includes one or more picture holders 140, a user interface 150 for playing and/or recording an audio file, and a series of holes 160 placed over a speaker/microphone 162 (shown in FIG. 5), and a trigger 170 for activating one or more functions of the speaker/microphone 162. According to an embodiment, the user interface 150 includes a button.

According to an embodiment, a user uses the button 150 to initiate a recording of an audio file. For example, the user may hold the button 150 down and speak into the speaker/microphone 162. The audio recording is saved in a memory in a circuit board 180 (shown in FIG. 5).

According to the embodiment shown in FIG. 3, the picture holder 140 is oval in shape and includes one or more securing mechanisms 142 for holding the picture in place. According to the embodiment shown in FIG. 4, the picture holder 140 includes a sleeve for inserting a picture. It is noted, however, that any suitable picture holder 140 may be used for securing one or more pictures or other media, while maintaining the spirit of the present invention.

According to an embodiment, at least one picture holder 145 is located on an inner portion of one or more flaps 120. A picture holder 145 on the inner portion of a flap 120 is visible only upon positioning the flap 120 in an unfolded position.

Referring now to FIG. 5, a front view, and internal components, of an interactive book covering 100 having unfolded flaps 120 is illustratively depicted, in accordance with an embodiment of the present invention.

According to an embodiment, the trigger 170 is attached to a circuit board 180, the circuit board 180 including at least a power source (such as, e.g., a battery), a memory, and a processor. According to an embodiment, when the flap 120 is placed in an unfolded position, the trigger 170 closes a circuit, triggering the circuit board 180 to send a pre-recorded audio file through a connector 170 (e.g., a wire) to the speaker/microphone 162, triggering the speaker/microphone 162 to audibly play the audio file.

According to an embodiment, the internal components are located between a front portion and rear portion of the backer 110 and are not clearly visible to a user through the backer 110.

According to an embodiment, the circuit board 180 may include a wireless data receiver (such as, e.g., a Bluetooth or Wifi adapter), enabling a user to wirelessly transfer one or more audio files to the memory in the circuit board 180. The circuit board may include these and other electric components. These electric components may, e.g., also include and/or power one or more light sources 190 (shown in FIG. 3). The light sources 190 may be positioned on or within the backer 110 in any location suitable for the lighting of a specific object or objects and may include any suitable light source (e.g., a light emitting diode).

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. An interactive book covering, comprising:
a backer;
one or more securing mechanisms for securing the backer to a cover of a book;
one or more flaps coupled to the backer and configured to fold over a front cover of the backer; and
one or more picture holders coupled to the backer, each picture holder being configured to secure one or more pictures.

2. The interactive book covering as recited in claim 1, further comprising one or more batteries configured to power one or more electric components coupled to the backer.

3. The interactive book covering as recited in claim 2, wherein the one or more electric components include:
a memory configured to store one or more audio recordings;
a processor configured to send the one or more audio recordings to a speaker; and
the speaker configured to play the one or more audio recordings.

4. The interactive book covering as recited in claim 3, wherein the one or more electric components include a microphone configured to record one or more audio files.

5. The interactive book covering as recited in claim 2, wherein the one or more electric components include one or more light sources.

6. The interactive book covering as recited in claim 1, wherein the one or more flaps, when folded over the front cover of the backer, cover the one or more picture holders.

7. The interactive book covering as recited in claim 1, wherein the one or more securing mechanisms are selectively removable from the cover of the book.

8. The interactive book covering as recited in claim 7, wherein the one or more securing mechanisms are foldable.

9. The interactive book covering as recited in claim 7, wherein the one or more securing mechanisms are rigid and configured to enable the cover of the book to be inserted into an opening formed by the one or more securing mechanisms.

10. The interactive book covering as recited in claim 1, wherein the one or more securing mechanisms include an adhesive.

11. An interactive book covering, comprising:
a backer;
one or more securing mechanisms for securing the backer to a cover of a hook, wherein the one or more securing mechanisms are selectively removable from the cover of the book;
one or more electric components coupled to the backer, wherein the one or more electric components include:
a memory configured to store one or more audio recordings;
a processor configured to send the one or more audio recordings to a speaker; and
the speaker configured to play the one or more audio recordings;
one or more flaps coupled to the backer and configured to fold over a front cover of the backer; and
one or more picture holders coupled to the backer, each picture holder being configured to secure one or more pictures.

12. The interactive book covering as recited in claim 11, further comprising one or more batteries configured to power the one or more electric components coupled to the backer.

13. The interactive book covering as recited in claim 11, wherein the one or more electric components further include a microphone configured to record one or more audio files.

14. The interactive book covering as recited in claim 11, wherein the one or more electric components further include one or more light sources.

15. The interactive book covering as recited in claim 11, wherein the one or more flaps, when folded over the front cover of the backer, cover the one or more picture holders.

16. The interactive book covering as recited in claim 11, wherein the one or more securing mechanisms are foldable.

17. The interactive book covering as recited in claim 11, wherein the one or more securing mechanisms are rigid and configured to enable the cover of the book to be inserted into an opening formed by the one or more securing mechanisms.
